(19) United States
(12) Patent Application Publication
(10) Pub. No.: US 2007/0058659 A1
(43) Pub. Date: Mar. 15, 2007

(54) METHOD FOR PROVIDING REQUESTED QUALITY OF SERVICE

(76) Inventors: Deepak V. Ayyagari, Vancouver, WA (US); Wai-Chung Chan, Vancouver, WA (US); Sherman L. Gavette, Camas, WA (US); Neal Riedel, Carlsbad, CA (US); Srinivas Katar, Ocala, FL (US)

Correspondence Address: MICHAEL BLAINE BROOKS, PC, P.O. BOX 1630, SIMI VALLEY, CA, 93062-1630, US

(21) Appl. No.: 11/420,432

(22) Filed: May 25, 2006

Related U.S. Application Data
(60) Provisional application No. 60/703,317, filed on Jul. 27, 2005.

(51) Int. Cl. H04L 12/413

(52) U.S. Cl. 370/445

(57) ABSTRACT

Methods, devices, and systems are provided wherein connections are requested with a connection specification that is based on whether the request is between a higher layer entity and a lower layer entity, between two stations, or between a station and a central coordinator. The connection specification may include QOS parameters and MAC parameters.

### CROSS-REFERENCE TO RELATED APPLICATIONS

This application claims the benefit of U.S. Provisional Patent Application Ser. No. 60/703,317 filed Jul. 27, 2005, entitled “Method for Providing Requested Quality of Service,” which is hereby incorporated by reference herein for all purposes.

### FIELD OF THE INVENTION

The invention relates to methods, devices, and systems for defining connection specifications, particularly within a centralized network.

### BACKGROUND

Connection specifications defining connection requirements are needed in a centralized network. A method of effectively and efficiently defining connections in a centralized network is thus highly desirable.

### SUMMARY

In one aspect of the invention, a method of establishing connections within a centralized network is provided. The method includes the steps of defining a connection specification (CSPEC) based on a CSPEC classification selected from at least one of the following: between a higher layer entity and a lower layer entity; between a first station and a second station; and between a third station and a central coordinator (CCO); requesting a connection associated with the defined CSPEC; and responding with a response indicating whether the requested connection has been granted or rejected. The step of requesting a connection is from at least one of the following: wherein the requesting step is associated with the defined CSPEC based on the CSPEC classification between the higher layer entity and the lower layer entity when the requesting step is between the higher layer entity and the lower layer entity; wherein the requesting step is associated with the defined CSPEC based on the CSPEC classification between the first station and the second station when the requesting step is between the first station and the second station; and wherein the requesting step is associated with the defined CSPEC based on the CSPEC classification between the third station and the CCO when the requesting step is between the third station and the CCO.

In another aspect of the invention, a device is provided. This device is adapted to be operably coupled to a centralized network that applies a connection specification classification based on whether a connection specification (CSPEC) is between a higher layer entity and a lower layer entity, between peer stations, and between a station and a central coordinator. The central coordinator coordinates the network activities. The device includes an admission control module (ACM) and a quality of service monitor module. The ACM is adapted to grant or reject a connection associated with a connection request from one or more stations within the network. This connection request is associated with a CSPEC defined within the centralized network to be applied between peer stations. The quality of service monitor module is operably coupled to the ACM and is adapted to monitor the connection granted by the ACM; gather statistics for the connection granted by the ACM; reconfigure the connection granted by the ACM when one or more violations of the associated CSPEC occur or when the associated CSPEC is modified; and teardown the connection granted by the ACM when the one or more violations of the associated CSPEC occur or when a teardown request of the connection is received

In another aspect of the invention, a central coordinator device is provided. This device is adapted to be operably coupled to a centralized network, which applies a connection specification classification based on whether a connection specification (CSPEC) is between a higher layer entity and a lower layer entity, between peer stations, and between a station and a central coordinator. The central coordinator coordinates the network activities. The device includes a bandwidth scheduling and allocation module, and a beacon configuration and transmission module. The BW scheduling and allocation module is adapted to grant or reject a connection associated with a connection request from one or more stations within the network, wherein the connection request is associated with a CSPEC defined within the centralized network to be applied between a station and a central coordinator; and schedule one or more time intervals for the connection within a contention-free period when the connection is granted. The beacon configuration and transmission module, on the other hand, is operably coupled to the BW scheduling and allocation module and is adapted to define a new beacon, once every beacon period, based on the scheduled one or more time intervals scheduled by the BW scheduling and allocation module; and transmit the defined beacon once every beacon period.

In another aspect of the invention, a system is provided. This system includes a central coordinator (CCO), a first station, and a second station is provided. This system is also a power line communication network. The CCO is operably coupled to the first station and the second station. The CCO is adapted to receive a request for a connection from at least one station, wherein the connection is associated with a connection specification (CSPEC) tailored between the CCO and a station, wherein the at least one station is selected from the group comprising the first station and a second station. The first station is operably coupled to the second station and wherein the first station is adapted to receive a request for a connection from the second station, wherein the connection is associated with a CSPEC tailored between peer stations; and wherein the first station comprises a first higher layer entity and a first lower layer entity adapted to receive a CSPEC tailored between a higher layer entity and a lower layer entity. The second station, on the other hand, is operably coupled to the first station, and wherein the second station is adapted to receive a request for a connection from the first station, wherein the connection is associated with a CSPEC tailored between peer stations; and wherein the second station comprises a second higher layer entity and a second lower layer entity adapted to receive a CSPEC tailored between a higher layer entity and a lower layer entity.

### BRIEF DESCRIPTION OF THE DRAWINGS

The present invention is illustrated by way of example and not limitation in the figures of the accompanying drawings, and in which:

FIG. 1 is a high-level block diagram of an exemplary network according to an embodiment of the invention;

FIG. 2 is an exemplary beacon according to an embodiment of the invention;

FIG. 3 is a high-level functional block diagram of an exemplary protocol architecture according to an embodiment of the invention;

FIG. 4 is a high-level block diagram showing the connection specification (CSPEC) classifications according to an embodiment of the invention;

FIG. 5 is a block diagram showing the connection between a higher layer protocol entity and a lower layer protocol entity, according to an embodiment of the invention;

FIG. 6 is a block diagram showing the connection between two stations according to an embodiment of the invention;

FIG. 7 is a block diagram showing the connection between a central coordinator and a station according to an embodiment of the invention;

FIG. 8 is a block diagram of another exemplary protocol architecture of a station, according to an embodiment of the invention;

FIG. 9 is a functional block diagram of an exemplary central coordinator according to an embodiment of the invention;

FIG. 10 is a more detailed functional block diagram of an exemplary bandwidth manager module according to an embodiment of the invention;

FIG. 11 is a functional block diagram of an exemplary station according to an embodiment of the invention;

FIG. 12 is a more detailed functional block diagram of an exemplary connection manager module according to an embodiment of the invention;

FIG. 13 is an exemplary data flow of messages exchanged between two stations according to an embodiment of the invention; and

FIG. 14 is an exemplary data flow of messages exchanged between a central coordinator and a station according to an embodiment of the invention.

### DETAILED DESCRIPTION OF THE INVENTION

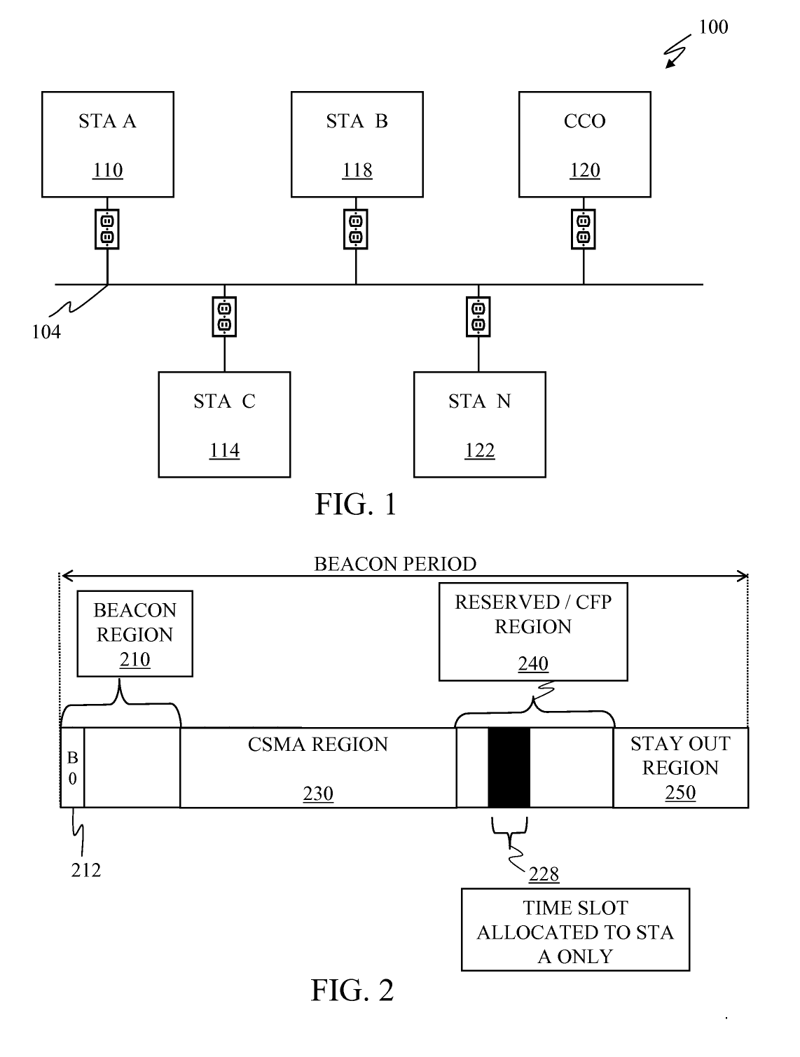

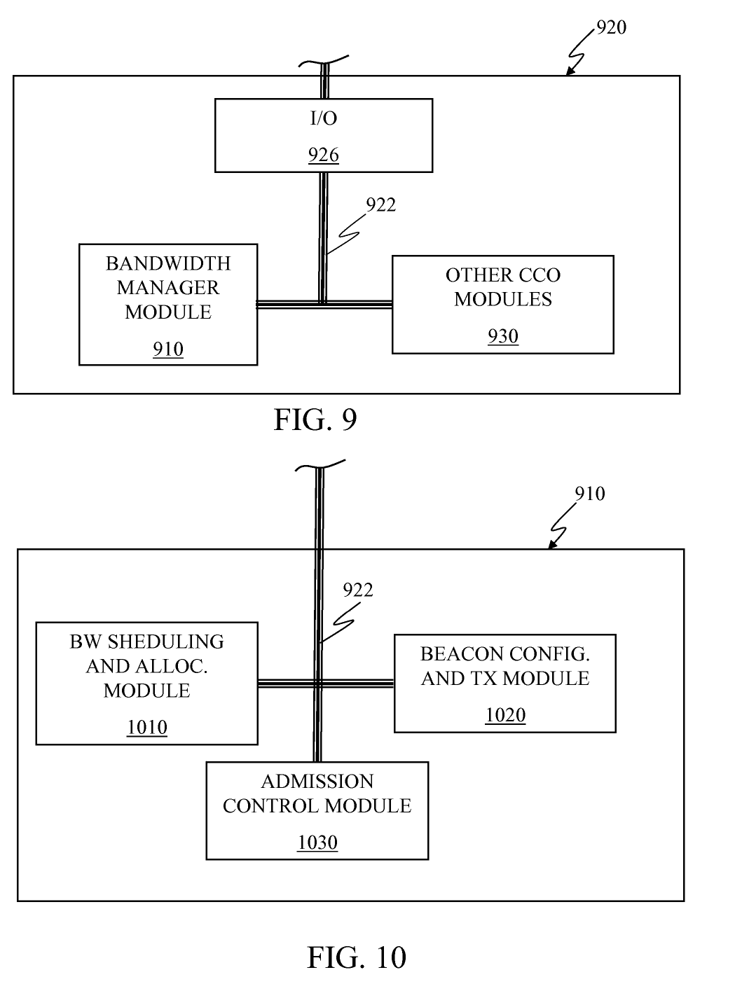

To better understand the figures, reference numerals within the one hundred series, for example, 100 and 118, are initially introduced in FIG. 1, reference numerals in the two hundred series, for example, 200 and 222, are initially introduced in FIG. 2, and so on and so forth. So, reference numerals in the nine hundred series, e.g. 910 and 930, are initially introduced in FIG. 9.

FIG. 1 is an exemplary diagram of a network 100 according to some embodiments of the invention. In some embodiments, the network has portions of its data communication network segments 104 over power lines. Power line communication (PLC), sometimes also called broadband over power line (BPL), is a wire-based technology—which in particular uses medium and low voltage power lines for data communications. These power line networks include networks created by using electrical wirings, for example, in homes and buildings. Data communicated for example, include, but are not limited to, music, streaming videos, files, voice, databases, text files, control commands, and network keys. This exemplary network 100 may also include other wired, e.g., Ethernet, or wireless networks.

The exemplary network 100, in this embodiment, includes one centralized network (CN). A CN typically includes a central network coordinator also called the central coordinator (CCO) 120 that controls network activities, such as network timing, bandwidth allocation, and security, e.g., authentication and key management. For each centralized network, there is typically one instance of a CCO 120 and zero or more stations 110, 114, 118, 122. In some embodiments, the CCO is the only device initially within the CN. In another exemplary embodiment, the data communication network 100 includes more than one centralized network, with each CN controlled by a CCO. When two or more CNs are available, these CNs may operate, for example, in the coordinated mode.

In some embodiments, the network is a power line communication (PLC) system. Stations 110, 114, 118, 122 that may be connected to this PLC network include devices such as monitors, TVs, VCRs, DVD player/recorders, other audiovisual devices, computers, game consoles, sound systems, information appliances, smart-home technology appliances, home audio equipment, or any other device that is PLC-enabled or compatible, or is able to communicate via the power lines. Although the embodiments of the invention herein are exemplified and discussed using power line networks, features of the present invention are also relevant to other networks; for example, but not limited to, networks, wired or wireless, that have a centralized architecture with a central coordinator controlling the activities of the stations in the network. The use of power line networks in exemplary configurations is intended to aid in understanding the features of the several embodiments of the invention.

In one embodiment of the invention, the network 100 may use time division multiplexing (TDM) as a method of multiple data streams sharing a medium/channel according to time segments. The data streams may be reconstructed according to their time slots. In general, TDM enables several users/stations to share the same frequency by dividing it into different time slots. The stations transmit in rapid succession, one after the other, each using their own defined time slot. Time division multiple access (TDMA) and TDM are techniques known to those of ordinary skill in the art and may be used with PLC technology. The networks of the present invention may also use other time-division multiplexing technology, and other technology such as orthogonal frequency-division or combinations and variations thereof. Other technologies supporting PLC, e.g., orthogonal frequency-division multiplexing (OFDM), however, may also be used within the network and system.

Beacons:

In some embodiments, a CCO 120 manages the activities of stations within its centralized network using, for example, beacons. Beacons are typically control messages that identify the frame configuration and the bandwidth (BW) assignments within a time frame to multiple networks and to stations within a given network. Beacons are typically broadcasted by each CCO, e.g., as a multi-network broadcast, and are decoded by the stations within the network and, in some embodiments by the CCOs of neighbor networks. Beacons are also typically tagged or identified, such that stations within a network decode and follow the BW allocation of its own network beacon and not the beacon of another network. Beacons are also transmitted or broadcasted, typically periodically, into the networks. In some embodiments, they are transmitted unencrypted. In an alternative embodiment, beacons or portions thereof are encrypted.

FIG. 2 is an exemplary diagram of a beacon period for the exemplary network 100 according to an embodiment of the invention. In some embodiments of the invention, a beacon period comprises several parts or regions. Each region is further typically defined into one or more time slots (e.g., 212 and 228). In some embodiments, a beacon period comprises four regions:

Beacon Region:

In some embodiments, a beacon region 210 is the region wherein a CCO is able to transmit its own beacon. The beacon region generally includes a plurality of a certain number of beacon or time slots, with the duration of each beacon slot typically sufficient for the transmission of a beacon. In some embodiments, the duration of each beacon slot is equal to the sum of the duration of a beacon PHY protocol data unit (PPDU) and the interframe space. A beacon region 210, in some embodiments, consists of one to a maximum number—typically defined within the system of time slots or beacon slots. In some embodiments, the size of the beacon region, including the number of time slots, may be adjusted dynamically by the CCO. In this exemplary embodiment, the CCO 120 transmits its own beacon at beacon time slot B0 212.

Carrier Sense Multiple Access (CSMA) region or Contention Period (CP) Region:

The CSMA region 230 is a region wherein any one or more of many contention access protocols are used to share the medium and to coordinate network traffic. In some embodiments, a CSMA/CA protocol may be used. A network may have one or more CP or CSMA regions. In some embodiments, to be compatible, the CSMA or CP regions of one centralized network do not overlap with the reserved or contention-free period regions of other networks. Communication, however, between two or more interfering networks may be made during overlapping CSMA regions.

For each network, a “minimum CSMA region” (MinCSMARegion) immediately following the beacon region is typically supported. The minimum CSMA region, together with other CSMA regions, located elsewhere in the beacon period, for example, may be used for the following:
Exchange of priority-based user data between STAs using CSMA, e.g., CSMA/CA;
New STAs, including CCOs, to associate with the network;
Existing STAs to exchange management messages with the CCO (e.g., to set up a new link);
New CCOs to exchange management messages to establish new neighbor networks; and
Existing neighbor coordinators to exchange management messages with the CCO (e.g., to share bandwidth, or to change the number of beacon slots).
   Reserved Region or Contention-Free-Period (CFP) Region:

The reserved or CFP region 240 is a period when only stations that have explicit authorization from the CCO are allowed to transmit. A reserved region is a time interval that is typically reserved by a network. The network that has been allocated or has acquired control of the reserved region typically schedules the transmission of its contention-free links here. In addition, the CCO may also schedule CSMA allocations that may be used only by the STAs in that network. For example, a time slot 228 in the reserved region 240 has been allocated by the CCO to STA A 110, so that STA A 110 may freely transmit at that time slot or interval 228 without interference, conflict, or contention from other stations 114, 118, 120, 122 within the network. Explained in another way, in that time slot 228, STA A may freely transmit, while other stations in that network are typically silent. This allocation is typically via beacons, such that when a station decodes its own network beacon, information about which station is to use that time slot may also be defined within that beacon. In other embodiments, the CCO sends a message directly to the station informing that station when to transmit and sometimes even listen. A network may have any number of reserved regions in a beacon period.

Stayout Region:

The stayout region 250 is a period within the time frame when all stations assigned a stayout region are instructed by the CCO to remain silent, meaning no transmission. Typically, these stations are also not to use any contention access or contention-free access protocol. A stayout region is assigned to avoid conflicts with a neighboring network that has been assigned a reserved region in the same time interval. In general, a network specifies a stayout region if one or more of the neighboring networks, typically defined for example within a network interfering list, have specified a reserved region or a protected region in the same time interval.

In some embodiments, the various types of regions need not be allocated in one contiguous time interval. This means for example, that the various types of regions may interleave each other, e.g., a time frame or beacon period includes a beacon region, followed by a CSMA region, followed by a stayout region, followed by another CSMA region, and then followed by a reserved region. The various regions within a beacon period may also be of varying sizes with varying number of time slot intervals or durations. In one embodiment, the end time of each region type within a beacon period is stored, for example, in multiples of a defined allocation time unit (e.g., “AllocationTimeUnit”), e.g., 0.32 msec.

In another alternative embodiment, a beacon period may include another region type (not shown) called a Protected Region. When a CCO detects the existence of another group, i.e., another CN or set of CNs with a different timing and if it optionally decides to coordinate with networks in that group, that CCO typically specifies a protected region in the same interval where the beacon region of the other group is located. Stations in a network typically are not allowed to transmit in a protected region. A neighboring group of networks, for example, may have a different beacon period start time.

Based on the beacons transmitted by the CCO, the devices within a network are able to share bandwidth using the same medium or channel, e.g. power line medium. The CCO in each network thus typically controls BW allocation and scheduling within its network. The stations within the network thus decode its own network beacons, and accordingly perform their functions, such as network transmission, following the beacon period allocations or schedule.

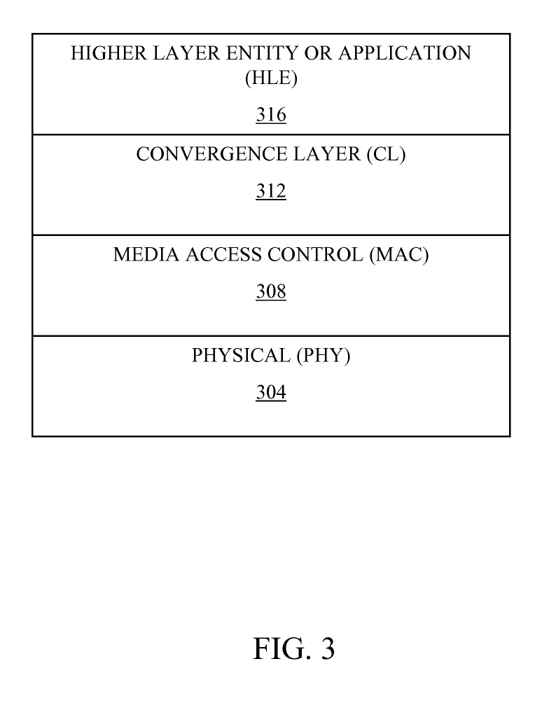

FIG. 3 is an exemplary protocol architecture of some embodiments of the present invention. These protocol layers may be associated with the Open System Interconnection (OSI) reference model. The lowest layer is the physical layer (PHY) 304, which typically transmits and receives raw bits over a communication channel and encodes and/or decodes signals. Above the PHY layer 304, is the media access control (MAC) 308 layer, which typically transmits data in frames. Above the MAC layer 308, is the convergence layer (CL) 312, which typically provides functions specific to the service being provided or requested. The convergence layer (CL) 312 is typically adapted to convert the service requirements of higher layer entities or applications 316 to the services offered by the lower layer entities 304, 308, 312. The CL 312 further provides a layer shielding higher-level applications 316 from the details or complexities of the MAC 308 and PHY 304 layers. The functions of the CL 312 may include, for example, mapping of higher layer control plane procedures to procedures supported by the lower layers or lower layer entities, encapsulating protocol date unit framing of upper layers into a native MAC/PHY frames, mapping an upper layer address into an appropriate address, translating upper layer quality of service (QoS) parameters into native MAC format, and the like. The higher layer entity or application 316 may include Ethernet, Internet Protocol (IP), ATM, FIREWIRE, IEEE 1394, Universal Plug and Play (UPnP), IP applications, digital audio/video multicasts, digital telephony, control applications, bridges, and the like.

Connections and Links:

In some embodiments, the network 100 provides connection-oriented service. A connection may be either unidirectional, i.e., data flows in only one direction, or bidirectional, i.e., data flows in both directions. A forward direction may be defined as the direction from the originating STA to the terminating STA and a reverse direction is the direction from the terminating STA to the originating STA. Explained in another way, a forward link is identified as originating at the STA that initiates the connection-establishment procedure and terminating on the station(s) responding to the connection establishment request. In some embodiments, connections are used to provide guarantees on Quality of Service (QoS). Connection-oriented traffic may use either the CFP or the CP/CSMA, typically depending on the QoS requirements of the connection.

A connection may be composed of links. A link is typically a unidirectional data flow, e.g., a packet or set of related packets, from typically the CL of the source of the link to the CL of one or more destinations of the link. Links may also be categorized as unicast or broadcast/multicast depending on the number of destinations of link. Unicast links typically have a unique destination whereas broadcast/multicast links have multiple destinations. In some embodiments, a connection may be composed of one of the following exemplary combinations of links:
1. A single unicast forward link from the station that initiated the connection to the terminating station of the connection;
2. A single unicast reverse link from the terminating station of a connection to the initiating station of the connection;
3. Both (1) and (2)—i.e., a bi-directional connection; and
4. A single multicast/broadcast link from the station that initiated the connection to the terminating stations of the connection.

In some embodiments, a distinction between connections and links is made because, at the physical layer, each direction between two stations is likely to have different characteristics and may be allocated separately, if so desired. Furthermore, in some embodiments, different types of links may be supported, e.g., a link controlled by the CCO 120 and those links controlled just by STAs 110, 118, 114, 122.

Typically, every connection and every link has a connection specification (CSPEC) associated with it. A CSPEC typically contains the set of parameters that defines the characteristics and QoS expectations of a connection. Connections may be either unidirectional or bi-directional. For bi-directional connections, a CSPEC is each defined for the forward link and the reverse link. A unidirectional connection may specify only forward or reverse direction QoS requirements, depending on the direction in which the connection's data traffic flows.

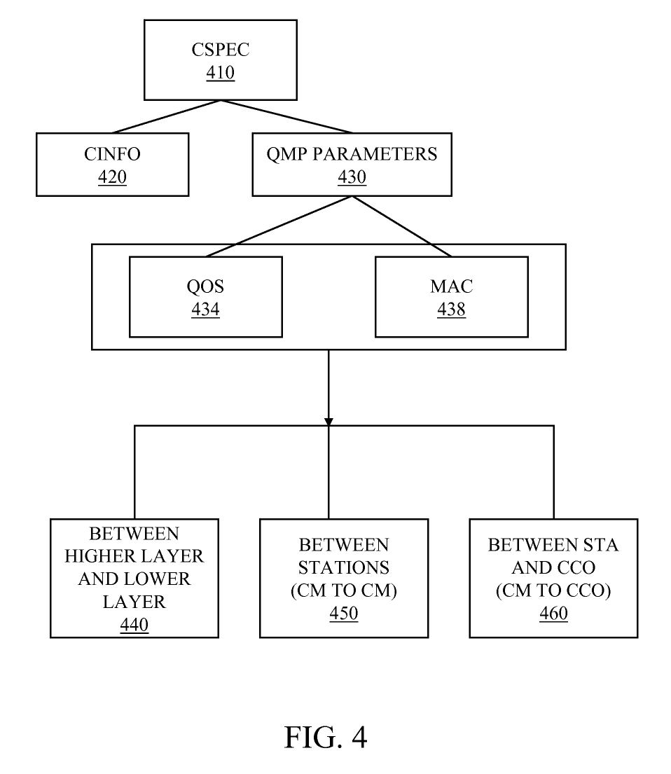

FIG. 4 is a block diagram showing the exemplary CSPEC classification types according to some embodiments of the invention. A CSPEC 410 typically includes connection information (CINFO) 420 and parameters 430. These QoS and MAC parameters (QMP) 430 typically include QoS parameters 434 to identify QoS requirements (e.g., delay, jitter, and data rates) and MAC parameters 438 that are specific to the particular connection. In some embodiments of the invention, there are at least three CSPEC connection or classification types 440, 450, 460. These CSPEC classification types consider three connection types or conditions, i.e., whether the connection request is between a higher layer and a lower layer connection 440, between two stations, i.e., a STA-to-STA connection 450, or between a STA and a CCO, i.e., STA-to-CCO 460 connection. In these embodiments, there is a distinction between a CSPEC for a connection between two stations with none of them functioning as a CCO—station-to-station, and a CSPEC for a connection between two devices with one station functioning as a CCO—STA-to-CCO. The CSPEC classification may be dependent on and relevant to the network itself, e.g., whether it is a PLC network, Ethernet network, or wireless network. The various CSPEC classification types support modes of operation that in some embodiments consider that certain parameters may only be controlled and operated upon within that type of connection, e.g., certain CSPEC and/or MAC parameters are applicable only between a STA and a CCO connection or applicable only within two stations. One of ordinary skill in the art will realize that variations on how a connection may be defined may be varied, for example, that the CINFO may be combined as part of the CSPEC and vice versa. Other data passing mechanisms and techniques on how to pass and/or format data may be used to vary how a connection is defined and yet still be in the scope of the present invention.

Typically, these groupings or classifications are made so as to: (1) maintain QoS information only where it is needed, e.g., in sending/receiving stations, within a station, or in the CCO, etc.; (2) NOT transmit QoS information across the network when the QoS is generally not needed by the receiving device; and (3) localize functions which operate on the QoS or MAC parameters to the particular network entity, e.g., station, peer station, or CCO, i.e., typically more capable of executing such functions. In some embodiments, these groupings or classification enable the more capable entity to address memory usage, protocol signaling, bandwidth usage, and maintenance of QoS level guarantees provided to applications by the network. For example, adjusting bandwidth allocation in time so that application delay QoS parameters is not violated due to changes in channel characteristics is typically done on a fast time scale by the peer stations and not the CCO. The embodiments of the CSPEC of several embodiments of the present invention enable a finer definition and control of connection requirements.

Table I below is an exemplary CSPEC format, with exemplary fields, according to some embodiments of the invention. Other variations in the manner of providing CSPEC information may be implemented and still be in the scope of the invention. For example, additional fields may be added, fields may be deleted, length of fields may be changed, fields may be subdivided into a number of subfields, etc.

TABLE I
Exemplary Connection Specification Format

| | Length | |
|---|---|---|
| Field | (Octets) | Definition |
| CSPEC_LEN | 2 | Length of CSPEC in octets |
| CINFO (Forward) | 1 or 5 | Forward Connection Information; e.g. 1 byte |
| | | is used if CINFO is invalid and 5 bytes is |
| | | CINFO is valid |
| CINFO (Reverse) | 1 or 5 | Reverse Connection Information; e.g. 1 byte |
| | | is used if CINFO is invalid and 5 bytes is |
| | | CINFO is valid |
| QMP (Forward) | var | Forward QoS and MAC Parameters |
| | | (typically only present if connection |
| | | requires a forward link) |
| QMP (Reverse) | var. | Reverse QoS and MAC Parameters |
| | | (typically only present if connection |
| | | requires a reverse link) |

The CSPEC may include forward connection information (CINFO), and forward QoS and MAC parameters (QMP)—if the connection includes a forward link, and reverse CINFO and reverse QoS and MAC parameters—if the connection includes a reverse link. In some embodiments, the CINFO, QoS, and MAC parameter fields apply to the forward and/or reverse link, as indicated in the CSPEC. CINFO typically identifies the attributes of the connection and the MAC and protocol adaptation layer (PAL) operations typically required or requested by the connection at the source and destination devices. In some embodiments, the CINFO, QoS, and MAC parameters specifically apply to forward or reverse links, as indicated in the CSPEC. In some embodiments, a separate CINFO is provided for each direction, e.g., one for the forward link and one for the reverse link. Table II below is an exemplary CINFO format, with exemplary fields.

TABLE II
Exemplary Connection Information Format (CINFO)

| | Length | | |
|---|---|---|---|
| Field | (Octets) | Description | Recfg. |
| Valid | 1 | “00000000” = CINFO is not valid; | No |
| CINFO | | “00000001” = CINFO is valid; | |
| | | This field is set to “00000000” if the corresponding | |
| | | link is not present. If set to “00000000,” the | |
| | | remaining fields in the CINFO and the corresponding | |
| | | QMP fields are not present or made available in the | |
| | | CSPEC. | |
| MAC | 1 | “00000000” = Contention-Free (CFP) Service; | No |
| Service Type | | “0000001” = Contention-Based (CP) Service; | |
| | | “00000010” = Unspecified - this MAC service type | |
| | | may be used by HLEs that do not care whether | |
| | | contention free or contention based service are | |
| | | provided to the corresponding link. If the HLE | |
| | | chooses this option, the connection manager (CM) of | |
| | | the STA at the initiating side of the connection | |
| | | typically uses the QoS and MAC parameters to | |
| | | determine whether the corresponding link services is | |
| | | contention free or contention-based. MAC service | |
| | | type is typically not set to unspecified when CSPEC | |
| | | parameters are exchanged between CMs (STA-to- | |
| | | STA) and between CM and CCO (STA-to-CCO). | |
| | | This field is typically only present when the Valid | |
| | | CINFO field is set to “valid.” | |
| User Priority | 1 | For contention-based service, this field indicates | Yes |
| | | connection priority, e.g., as defined in subclause | |
| | | 7.7.3 of IEEE 802.1D. | |
| | | This field is typically only present when the Valid | |
| | | CINFO field is set to “valid.” | |
| Arrival Time | 1 | “00000000” = ATS not passed to the HLE; | No |
| Stamp to | | “00000001” = ATS to be passed to the HLE (at the | |
| HLE (ATS) | | receiver) for each MAC Service Data Unit (MSDU). | |
| | | This field is typically only present when the Valid | |
| | | CINFO field is set to “valid.” | |
| Smoothing | 1 | “00000000” = smoothing is not requested; | No |
| | | “00000001” = if supported, receiver to activate | |
| | | smoothing function/delay compensation function. | |
| | | This field is typically only present when the Valid | |
| | | CINFO field is set to “valid.” | |

Typically, the QoS parameters of a STA are generated by a connection manager (CM), which in some embodiments are via PAL-specific primitives exchanged between the higher layer applications (HLEs) and the CM and via other connection service functions available.

Each QoS and MAC parameter typically consists of the fields shown in Table III below. Table III shows an exemplary format of QoS and MAC parameters or parameter fields in CSPEC.

TABLE III
Exemplary Format of QoS and MAC Parameter Fields (QMPs) in CSPEC

| | Length | |
|---|---|---|
| Field | (Octets) | Description |
| Forward/ | 1 | “00000000” = forward (from source |
| Reverse | | to receiver); |
| (F/R) | | “00000001” = reverse (from receiver to source) |
| Length (LEN) | 1 | Length of the body field, e.g., in octets |
| Field Identifier | 1 | Identifier of the QoS and MAC parameter field |
| (FID) | | |
| Body | var | Data of the QoS and MAC parameter field |

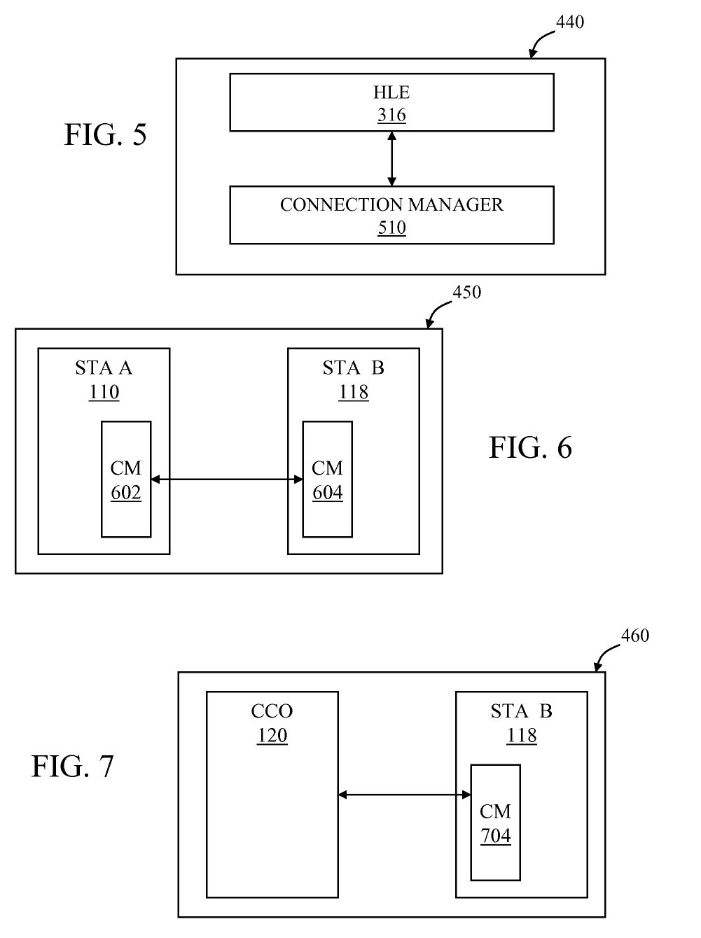

FIG. 5 is a high-level block diagram of an exemplary CSPEC classification or connection type 440, according to an embodiment of the invention, wherein a specific set of QMPs is defined for a connection between an HLE 316 and a lower protocol layer, for example, a connection manager (CM) 510. Exemplary QMPs that may be exchanged between the HLE 316 and CM 510 are shown in Table IV below.

TABLE IV
Exemplary QMPs exchanged between a HLE and CM (Higher Layer-to-Lower
Layer Connection) and between CMs (STA-to-STA connection)

| | FID | | | |
|---|---|---|---|---|
| | (see | | | |
| | Table | | | |
| | III | LEN | | |
| CSPEC Field | above) | (Octets) | Description | Recfg. |
| Delay Bound | “0” | 4 | Maximum amount of time specified to | Yes |
| | | | transport an MSDU, measured from | |
| | | | the time the MSDU arrives at the CL | |
| | | | SAP of the transmitting station until | |
| | | | the time the MSDU is transmitted or | |
| | | | retransmitted successfully across the | |
| | | | network, e.g. power line network, and | |
| | | | delivered out of the CL SAP of the | |
| | | | receiving station(s). Unit is in | |
| | | | microseconds. | |
| Jitter Bound | “1” | 4 | Maximum difference in the delay | Yes |
| | | | experienced by an MSDU. Delay is | |
| | | | typically measured from the time the | |
| | | | MSDU arrives at the CL SAP of the | |
| | | | transmitting station until it is | |
| | | | successfully delivered out of the CL | |
| | | | SAP of the receiving station(s). Unit | |
| | | | is microseconds. | |
| Nominal | “2” | 2 | Nominal MSDU Payload Size in | Yes |
| MSDU Size | | | octets | |
| Maximum | “3” | 2 | Maximum MSDU Payload Size in | Yes |
| MSDU Size | | | octets. If this parameter is not | |
| | | | specified, a value of “Default | |
| | | | Maximum MSDU Size” is assumed. | |
| Average Data | “4” | 2 | The average application data rate | Yes |
| Rate | | | specified at the CL SAP that is | |
| | | | typically required for transport of | |
| | | | MSDUs belonging to this Link. This | |
| | | | typically does not include the MAC | |
| | | | and PHY overhead incurred in | |
| | | | transferring the MSDU. Exemplary | |
| | | | unit is in multiples of 10 kilobits per | |
| | | | second (kbps), e.g., 0 kbps, 10 kbps, | |
| | | | 20 kbps, etc. | |
| Minimum Data | “5” | 2 | The minimum application data rate | Yes |
| Rate | | | specified at the CL SAP that is | |
| | | | typically required for transport of | |
| | | | MSDUs belonging to this Link. This | |
| | | | does not include the MAC and PHY | |
| | | | overhead incurred in transferring the | |
| | | | MSDU. | |
| | | | Exemplary unit is in multiples of 10 | |
| | | | kilobits per second (kbps). | |
| Maximum | “6” | 2 | The maximum application data rate | Yes |
| Data Rate | | | specified at the CL SAP that is | |
| | | | typically required for transport of | |
| | | | MSDUs belonging to this Link. This | |
| | | | field typically does not include the | |
| | | | MAC and PHY overhead incurred in | |
| | | | transferring the MSDU. Exemplary | |
| | | | unit is in multiples of 10 kilobits per | |
| | | | second (kbps). | |
| Maximum | “7” | 2 | Maximum time typically allowed | Yes |
| Inter-TXOP | | | between two transmission | |
| time | | | opportunities (TXOPs) on the medium | |
| | | | for this link. Unit is in microseconds. | |
| Minimum | “8” | 2 | Minimum time typically allowed | Yes |
| Inter-TXOP | | | between two transmission | |
| time | | | opportunities (TXOPs) on the medium | |
| | | | for this link. Unit is in microseconds. | |
| Maximum | “9” | 2 | Maximum size of a single contiguous | Yes |
| Burst Size | | | burst of MSDUs that is generated by | |
| | | | the application at the maximum rate. | |
| | | | Unit is in octets. | |
| Exception | “10” | 1 | “00000000” = terminate the | Yes |
| Policy | | | connection; | |
| | | | “00000001” = re-configure the | |
| | | | connection | |
| Inactivity | “11” | 4 | Maximum duration of time a | Yes |
| Interval | | | connection is typically allowed to | |
| | | | remain inactive without transporting | |
| | | | any application data before the CM | |
| | | | may release the allocation. The units | |
| | | | are in milliseconds. | |
| | | | “00000000” = indefinite inactivity | |
| | | | interval (i.e., connection should be | |
| | | | considered active until explicitly | |
| | | | terminated); | |
| | | | “00000001” = 1 millisecond, etc. | |
| MSDU Error | “12” | 2 | MSDU error rate requested. It is | Yes |
| Rate | | | typically expressed as x·10^{-y}. The | |
| | | | value of x is specified in the most | |
| | | | significant 8 bits in unsigned integer | |
| | | | format. The value of y is specified in | |
| | | | the least significant 8 bits in unsigned | |
| | | | integer format. | |
| CLST | “13” | 1 | Convergence Layer SAP Type | No |
| | | | This field typically supports | |
| | | | negotiation of connections using CL | |
| | | | SAPs other than, for example, the | |
| | | | 802.3 SAP. If this field is not present, | |
| | | | the 802.3 SAP is assumed. | |
| | | | “00000000” = IEEE 802.3 SAP | |
| CDESC | “14” | 77 or 101 | Connection Descriptor (CDESC) | Yes |
| Vendor | “15” | Var | Vendor-Specific QoS and MAC | Yes |
| Specific | | | information | |
| ATS Tolerance | “16” | 2 | Measured variance in value of Arrival | Yes |
| | | | Time Stamp (ATS) from a | |
| | | | synchronized network clock at the | |
| | | | time the ATS is applied to the MSDU | |
| | | | arriving at the Convergence Layer | |
| | | | (CL) SAP of the transmit station. Unit | |
| | | | is in microseconds. | |
| Smallest | “17” | 2 | This field indicates the smallest | No |
| Tolerable | | | average Data rate at which the | |
| Average Data | | | application is capable of operating. | |
| Rate | | | Exemplary unit is in multiples of 10 | |
| | | | kilobits per second (kbps). | |
| Original | “18” | 2 | Original Average Data Rate indicates | No |
| Average Data | | | the average data rate at which the | |
| Rate | | | application is to operate when | |
| | | | sufficient station and network | |
| | | | resources are available. Exemplary | |
| | | | unit is in multiples of 10 kilobits per | |
| | | | second (kbps). | |

The tables shown in this disclosure contain exemplary fields. One of ordinary skill in the art will realize that variations on the fields used, as well as the possible values, are expected and still be within the scope of the invention. Additional fields may be added, as well as removed, and still be in the scope of the present invention.

Exemplary Ordering of Fields with CSPEC:

In some embodiments, the fields within a CSPEC—e.g., those exchanged between CMs and between a CM and a CCO—may be organized in a certain manner. For example, if the CSPEC contains both Forward Link and Reverse Link CSPECs, the Forward Link QMP field(s) are presented before the Reverse Link QMP(s). In some embodiments, within the CSPEC of each link, the QMP fields are arranged in ascending order of the Field Identifier (FID) values. For example, if delay and jitter parameters are both exchanged for the Forward Link between two CMs, the delay bound parameter with FID=“0” appears before the jitter parameter, with FID=“1,” in the Forward Link CSPEC.

FIG. 6 is a high-level block diagram of an exemplary embodiment 450 wherein a specific set of CSPEC is defined for another CSPEC classification, i.e., a STA-to-STA connection. A STA 110, 114, 118, 122 typically has a connection manager (CM) that enables communication with another CM 602, 604 of another station. Exemplary QMPs that may be exchanged between two stations are shown in Table IV above and Table V below. Table V lists additional exemplary parameters that may be exchanged between two CMs. The QMPs in Table V are typically not present when the connection classification is for a CSPEC between HLEs and lower layer entities.

TABLE V
Exemplary Additional QMPs Exchanged Between Two Stations

| | FID | | | |
|---|---|---|---|---|
| | (see | | | |
| QoS and MAC | Table | | | |
| Parameter Field | III | LEN | | |
| (CM—CM) | above) | (Octets) | Description | Recfg. |
| RX Window Size | “19” | 2 | Receive window size in number of, | Yes |
| | | | for example, 512-octet segments. | |
| Smoothing Buffer | “20” | 3 | The smoothing buffer size in octets | Yes |
| Size | | | that is typically used to support the | |
| | | | Link at the transmitter and receiver. If | |
| | | | this field is not present and smoothing | |
| | | | is requested, the default buffer size is | |
| | | | chosen to be the product of Delay (in | |
| | | | seconds) and Average Data Rate (in | |
| | | | bits per second) | |

FIG. 7 is a high-level block diagram of an exemplary embodiment 460 wherein a CSPEC is defined for another connection classification, i.e., between a CCO and a STA. Table VI below lists exemplary QMPs exchanged between a station and the CCO.

TABLE VI
Exemplary QMPs for a connection between a STA (CM) and a CCO

| | FID | | | |
|---|---|---|---|---|
| | (see | | | |
| QoS and MAC | Table | | | |
| Parameter Field | III | LEN | | |
| (CM-CCO) | above) | (Octets) | Descriptions | Recfg. |
| TXOPs per | “64” | 1 | The number of uniformly spaced | No |
| Beacon Period | | | TXOPs requested per Beacon Period. | |
| | | | E.g., “00000000” = 1 TXOP per | |
| | | | Beacon Period, “00000001” = 2 TXOPs | |
| | | | per Beacon Period, etc. | |
| Average Number | “65” | 2 | The average number of 520-octet PHY | Yes |
| of PHY Blocks | | | Blocks per TXOP typically used for | |
| (PBs) per TXOP | | | transporting MSDUs belonging to this | |
| | | | link. | |
| Minimum | “66” | 2 | The minimum number of 520-octet | Yes |
| Number of PBs | | | PHY Blocks per TXOP typically used | |
| per TXOP | | | for transporting the MSDUs belonging | |
| | | | to this link. | |
| Maximum | “67” | 2 | The maximum number of 520-octet | Yes |
| Number of PBs | | | PHY Blocks per TXOP typically used | |
| per TXOP | | | for transporting the MSDUs belonging | |
| | | | to this link. | |
| PPB_Threshold | “68” | 2 | The Pending PHY Block (PPB) | Yes |
| | | | threshold indicates the threshold of | |
| | | | Pending PBs at which the Link | |
| | | | typically requires extra bandwidth to | |
| | | | clear the backlog. If there is sufficient | |
| | | | bandwidth available, the CCO may | |
| | | | provide Extra Allocation whenever the | |
| | | | PPB threshold is exceeded. | |
| Surplus | “69” | 2 | Surplus Bandwidth | No |
| Bandwidth | | | | |
| Exception Policy | “10” | 1 | “00000000” = terminate the | Yes |
| | | | connection; | |
| | | | “00000001” = reconfigure the | |
| | | | connection. | |
| CDESC | “14” | 77 or | Connection Descriptor | Yes |
| | | 101 | | |
| Vendor Specific | “70” | var | Vendor-specific QoS and MAC info. | Yes |
| Smallest | “71” | 2 | Smallest Tolerable Average Number of | No |
| Tolerable | | | PBs per TXOP indicates the smallest | |
| Average Number | | | average number of PBs per TXOP at | |
| of PBs per TXOP | | | which the application is capable of | |
| | | | operating. | |
| Original Average | “72” | 2 | Original Average Number of PBs per | No |
| Number of PBs | | | TXOP indicates the average number of | |
| per TXOP | | | PBs per TXOP at which the application | |
| | | | intends to operate when sufficient | |
| | | | station and network resources are | |
| | | | available. | |

Connection Description (CDESC)

The QoS and MAC parameters of the CSPEC exchanged between the HLE and CM (higher layer and lower layer 440), between CMs (STA-to-STA) 450 and between a CM and a CCO (STA-to-CCO) 460 may optionally include a connection descriptor (CDESC). CDESC is a set of fields, which defines the connection to the HLEs, e.g., see Table VII below. The CDESC is typically used by Universal Plug and Play (UPnP) QoS and other HLEs. CDESC is typically used only by the HLE and is usually passed to all involved parties, STAs, including the CCO, thereby enabling the HLE to later construct a list of the active connections without having to query every STA. In some embodiments, there is only at most one CDESC per CSPEC, even if the connection is bidirectional, and the Forward/Reverse field of the corresponding QMP field is typically ignored by the receiving entities.

TABLE VII
Exemplary Format of the Body of a Connection Descriptor (CDESC)

| | LEN | |
|---|---|---|
| CDESC Field | (Octets) | Description |
| IP Version | 1 | IP protocol version, e.g., |
| | | “00000000” = IP Version 4; |
| | | “00000001” = IP Version 6. |
| Source IP Addr | 4 or 16 | IP Address of Source HLE; |
| | | 4 Octets Long for IP v4, 16 |
| | | Octets Long for IP V6 |
| Source IP Port | 2 | IP Port number (corresponding to the |
| | | Protocot Type) of Source HLE |
| Destination IP Addr | 4 or 16 | IP Address of Destination HLE; |
| | | 4 Octets Long for IP v4, |
| | | 16 Octets Long for IP V6 |
| Destination IP Port | 2 | IP Port number (corresponding to |
| | | the Protocol Type) of Destination HLE |
| Protocol Type | 1 | IP Protocol Type (e.g., TCP, UDP) |
| CHFID | 64 | Connection's Human |
| | | Friendly ID (Optional) |

Vendor-Specific QoS and MAC Parameters

In some embodiments, QMPs of the CSPEC exchanged between the HLE and the CM, between CMs, and between the CM and the CCO may optionally include vendor-specific parameters. Vendor-specific QMP typically has a special Field Identifier (FID) value to identify it as such, e.g., the FID are set to all “1's” that is with a value of “255.” For example, the first three octets of the Body field of this parameter (see Table III) may be an IEEE-assigned Organizationally Unique Identifier (OUI) as exemplified in Table VIII below.

TABLE VIII
Exemplary Format of the Body of Vendor-Specific QMPs

| | | | Size | |
|---|---|---|---|---|
| Field | Octet | Bit Number | Bits | Definition |
| OUI | 0 | 7-0 | 8 | OUI first octet |
| | 1 | 7-0 | 8 | OUI second octet |
| | 2 | 7-0 | 8 | OUI third octet |
| Vendor | — | — | — | Vendor defined (based on |
| Defined | | | | implementation) |

Surplus Bandwidth

In some embodiments, surplus bandwidth (BW), see Table VI, is included as part of the QMP of the CSPEC. A surplus BW field typically indicates the excess amount of BW typically required to support the link relative to the average number of PBs per transmit operation. A value of “00,” for example, may indicate that no surplus BW is required, while a value of “01” may indicate one PB per transmit operation amount of surplus BW is typically required.

In some embodiments, a CCO typically uses surplus BW during the initial admission control procedure. A connection is typically rejected if the average number of PBs per transmit operation along with the requested surplus BW may not be allocated.

Set of QoS and MAC Parameters

In some embodiments, if contention-free service is requested in the MAC Service Type parameter of CINFO, the average data rate, and at least one of delay bound and maximum inter-TXOP time fields are specified between the HLE and the CM. Typically, the receive window size is also defined between a connection CSPEC between two stations, e.g., between two CMs. Moreover, if contention-free service is requested in the MAC service type parameter of CINFO, the connection CSPEC between the STA and the CCO includes the TXOPs per beacon period and the average number of PBs per TXOP fields.

In some embodiment, some CSPEC fields may be modified or reconfigured over the life of the connection. Some exemplary fields that may be reconfigured are shown in Tables II, IV, V, and VI above, indicated by a “Yes” in the last column, i.e., the “Reconfigurable” column. A connection modification request, however, is typically rejected if the reconfigured CSPEC may not be supported.

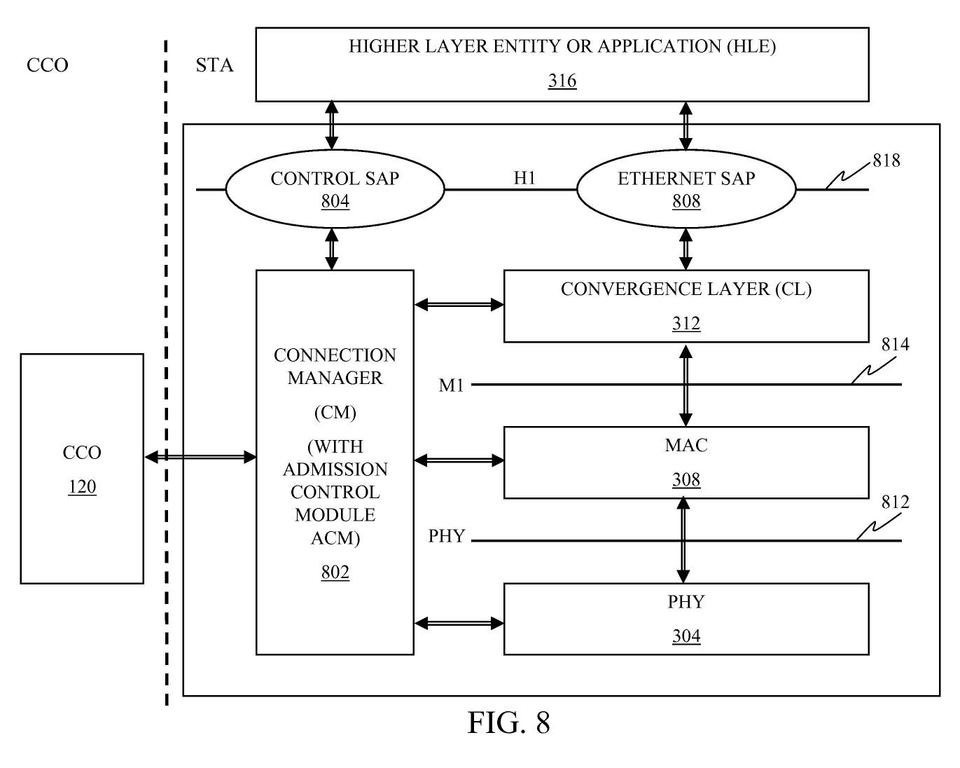

FIG. 8 shows an exemplary system architecture showing the protocol layers in more detail and in conjunction with a CCO. Typically, the connections for a STA are managed by a connection manager (CM) 802. Connections between stations are typically also handled by the CMs of each station. In this exemplary architecture, the CCO 120 communicates with a connection manager (CM) 802. Between adjacent layers is typically an interface 818, 814, 812, which defines which primitive operations and services the lower layer makes available to the upper or higher layer. Typically, the HLE 316 communicates with the CL 312 through service access points (SAPs) 804, 808 at the H1 interface 818, which is between the HLE 316 and the CL 312. The CL 312, in some embodiments, implements protocol adaptation layers (PAL) to service the SAPs and exchange data with the HLE. In this exemplary embodiment, an Ethernet service access point (SAP) 808 is shown at the H1 interface 818 between the HLE 316 and the CL 312. Furthermore, a control SAP 804 is between the HLE 316 and the CM 802. A control SAP 804 typically enables the HLE 316 to create and manage connections, monitor status and statistics, support vendor-specific primitives, and initialize stations. An M1 interface 814 is between the CL 312 and the MAC layer 308. In some embodiments, a SAP is used by the CL to pass data received from the HLEs to the MAC 308. A PHY interface 812 is between the MAC layer 308 and the PHY layer 304. The Ethernet SAP 808, for example, may support applications using Ethernet II class packets.

In some embodiments, a connection is created when the HLE 316 in a given station initiates a messaging sequence to set up the connection. Based on the CSPEC provided by the HLE 316, the CM 802 in this station determines how many links are required and whether each link should be a global link or local link. The CM 802 then communicates with the CM in the destination station (not shown), and possibly with the CCO 120, to establish the one or more links to establish or create the connection. Once the connection is established, the CM 802 is responsible for monitoring the QoS performance of each of its links. If a link is not performing according to its CSPEC, the CM 802 typically initiates a link reconfiguration with a new CSPEC or it may tear down the connection. In some embodiments, it is possible to have several connections between two STAs. In some embodiments, the connection may be between more than two stations. Each of these connections may have either global or local links along with its own, possibly unique, CSPEC.

In some embodiments, global links are established and controlled by the CCO 120 at the request of a CM 802. The source STA and the destination STA, for example, may request sufficient BW from the CCO to guarantee QoS. The CCO typically assigns the global link a dedicated BW allocation and a global link ID (GLID) that is typically unique in a network. In some embodiments, until the CCO assigns the GLID, the global link may be identified by the Connection ID (CID) assigned by the station that initiated the connection. Typically, each connection requested is associated with a CID. In some embodiments, a global link is managed globally by the CCO and locally by the CMs on each of the STAs involved in the connection. A global link may be used in contention-free and contention traffic. A GLID may also be used to identify different types of allocation. For contention-free allocation, for example, the GLID or another field may be used to identify the unique link that may use the medium. For example, identify a local CSMA allocation, a shared CSMA allocation that may be used when the network is operating in a coordinated or compatible mode, identify an allocation used by a designated STA to transmit a beacon, for example, and identify a unique contention-free link in the network.

In some embodiments, local links are used for contention-oriented traffic carried within the contention period. Typically, the CCO is not involved in establishing or controlling local links. The CMs of the STAs typically manages these local links and is responsible for assigning, for example, a local link ID (LLID) to identify the link between the STAs. In some embodiments, local links are used for connection-oriented applications that are not BW demanding, but would like to support, for example, in-order delivery. Packets received may be delivered to the appropriate SAP at the destination STA based on the GLID or LLID, for example.

FIG. 9 is a functional high-level block diagram of an exemplary CCO 120 of the present invention. In some embodiments, a CCO 120 includes a bandwidth (BW) manager module 910, an input/output (I/O) interface module 926, and one or more other CCO modules 930. The I/O interface module 926 typically enables the CCO 120 to communicate with other devices and stations within the network. Other CCO modules 930, for example, may include an association and authentication module, an encryption module, and other modules used by the CCO to perform its CCO functions in coordinating and managing the various devices within the network. An association and authentication module, not shown for example, is adapted to respond to association and authentication requests from stations requesting association and authentication with the network. An encryption module, for example, is adapted to respond and transmit encryption keys used within the network. In some embodiments, the different modules, including sub-modules, if any, may communicate and interface with each other via a bus, dedicated signal paths or one or more channels 922. One of ordinary skill in the art will appreciate that other various modules may be incorporated in the CCO.

FIG. 10 is a more detailed functional diagram of the BW manager module 910, which typically includes a BW scheduling and allocation module 1010, an admission control module 1030, and a beacon period configuration and transmission (TX) module 1020. In some embodiments of the invention, the BW scheduling and allocation module 1010 responds to requests for BW assignments for connections, e.g., connection establishments and connection reconfigurations, from STAs in the network. Typically each connection request is identified by a connection ID (CID), which typically serves as a unique identifier for that request. Each connection request typically may identify a forward and/or reverse link. Such connection requests are thus responded to, if appropriate, by assigning global connection links, with each connection link typically identified with a global connection ID (GLID). The GLID typically is associated with a schedule allocation of that connection. Typically, the traffic characteristics, quality of service (QoS) guarantees, media access control (MAC), and MAC parameters specific to a connection are defined in an associated connection specification (CSPEC). The BW scheduling and allocation module 1010 thus typically receives the CSPEC—typically associated with the connection request—that is defined to be applied between a station and a CCO (STA-to-CCO). In some embodiments, for example, the BW scheduling and allocation module 1010 schedules or allocates BW assignments in the form of time grants or time allocation, typically defined or specified via a beacon, e.g., as shown in FIG. 2. Furthermore, sounding and channel estimation results may be used by the BW manager module 910 in making allocations to connection requests. The BW scheduling and allocation module 1010 may also receive requests from stations requesting that the allocations be released, typically for use by other stations within the network.

When a CCO receives a connection-establishment or connection-reconfiguration request from a STA, the admission control module 1030 determines if there is adequate bandwidth to support such request, without compromising the QOS of existing connections. The admission control module 1030 is thus responsible for either accepting or rejecting such requests.

The beacon period configuration and TX module 1020, in some embodiments, defines an appropriate beacon schedule, based on, for example, the scheduling provided by the BW scheduling and allocation module 1010. The beacon may be constructed or updated based on the receipt by the CCO 120 of requests for new links from STAs within the networks, receipt of link reconfiguration requests associated with existing links within the network, and changes to the capacity of existing links as a result of changes to the physical channel. A beacon is typically broadcasted once every beacon period, e.g., showing allocations within a beacon period, by the beacon configuration and TX module 1020 via the I/O interface 926. In some embodiments, the beacon period configuration and TX module 1020 ensures that neighbor centralized networks, for example, a system with two centralized networks and thus two CCOs, are compatible or operating in the coordinated mode. In general, this means, for example, if one CCO allocates a CFP period for one of its STAs in the CN, the other neighbor CCO allocates a stayout region for its STAs in that neighbor network. If one CCO allocates a CSMA period, the neighbor CCO may specify a CSMA or a stayout region or period for the STAs within that neighbor network.

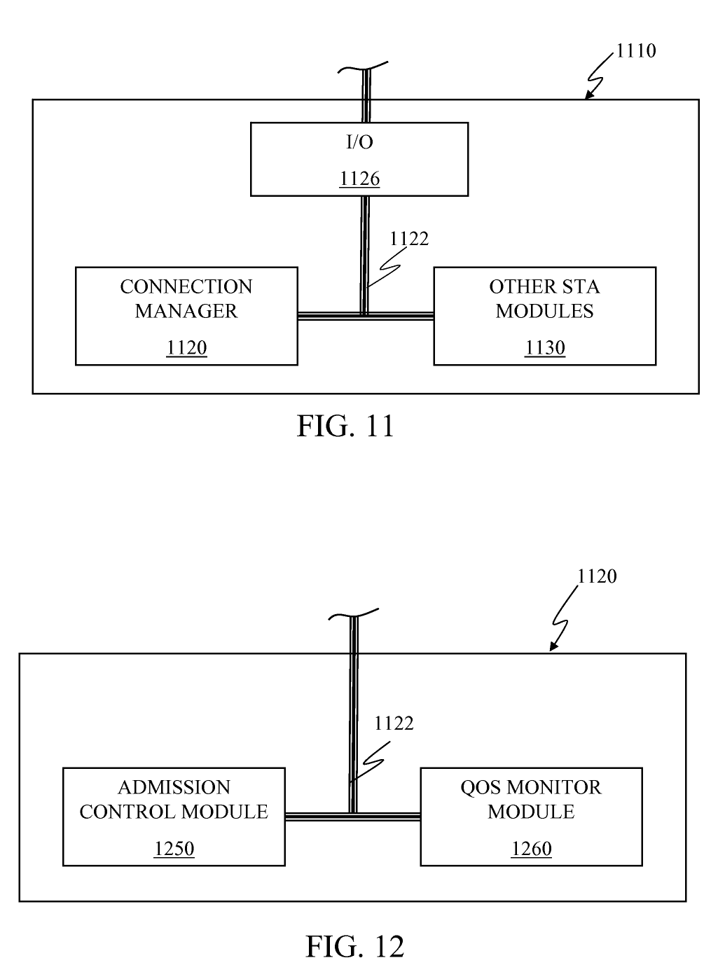

FIG. 11 is a high-level functional block diagram of an exemplary STA 110 according to some embodiments of the invention. Typically, a STA includes an I/O interface 1126 enabling the STA to communicate with other devices within the network. It also typically includes a connection manager 1120. Other STA modules 1130 may also be incorporated in the STA, for example, an encryption and decryption module adapted to encrypt and decrypt network messages, a beacon decoder module adapted to decode the beacon configuration for that network, and the like. In some embodiments, the different modules, including sub-modules, if any, may communicate and interface with each other via a bus, dedicated signal paths or one or more channels 1122. One of ordinary skill in the art will appreciate that other various modules may be incorporated in the STA.

FIG. 12 is a high-level functional block diagram showing the connection manager 1220 in more detail. Typically, a CM 1120 includes an admission control module 1250 and a QoS monitor module 1260. The admission control module (ACM) 1250, in some embodiments, is typically responsible for either accepting or rejecting connection establishment or connection reconfiguration requests from STAs within the network. Each of these requests is typically associated with a CSPEC defined to be used or applied between a STA-to-STA connection or CSPEC classification. The ACM 1250 also typically determines whether there is adequate BW available to support a BW request for a connection, typically without compromising the QoS of existing connections.

The QoS monitor module 1260 typically monitors and gather statistics for each link. Thus in some embodiments, the QoS monitor module 1260 ensures that the station and the network resources are not over allocated, thereby ensuring the QoS guarantee on accepted/admitted connections. Typically, the admission control module 1250 executes an admission control procedure whenever a new connection, including a new global link, is requested or an existing local connection, including an existing global link, is modified. The QoS monitor module 1260 also typically continuously monitors existing connections, including links, for adherence to the negotiated traffic characteristics (traffic policing) and QoS guarantees.

Violation of the CSPEC parameters, e.g., insufficient BW available, in some embodiments, may cause the QoS monitor module 1260 to reconfigure or tear down an existing connection or global link, which in some embodiments, may depend on the CSPEC's violation policy parameter defined, if any. If a link is torn down, the associated or corresponding connection is typically also torn down.

One of ordinary skill in the art will appreciate that variations on the module of the CCO and the STA are expected. For example, the various modules may be further subdivided into more modules or be incorporated into one main module. Various other divisions and incorporation of functions may also be implemented. The modules in the CCO and the STA also typically interface with each other via the bus.

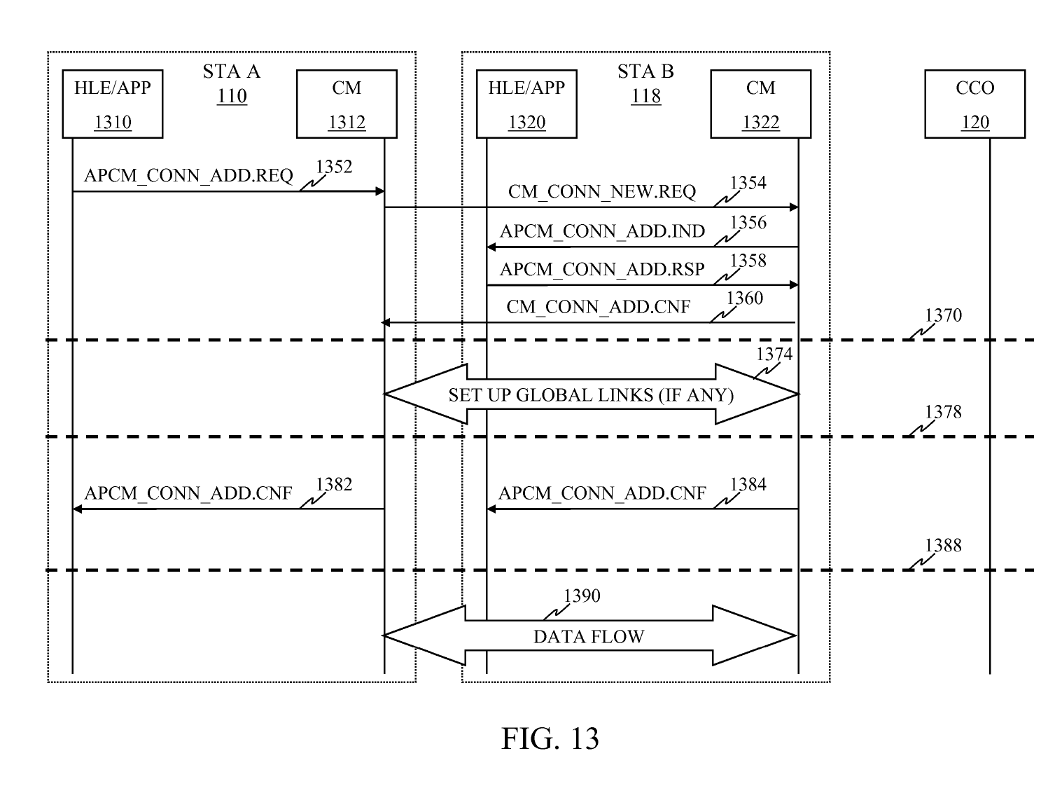

FIG. 13 is a data flow diagram showing how a connection may be established between two stations according to some embodiments of the invention. These messages exchanged to establish connection between two stations, however, may also be applied to three or more stations. To request establishment of a new connection, an application or an HLE 1310 of a STA, e.g., STA A 110, typically requests its associated lower layer CM 1312, e.g., via an APCM_CONN_NEW.REQ message 1352, to establish a connection. This message requesting new connection 1352 typically provides or informs the CM 1312 the CSPEC for the new connection (e.g., see Table I above), the originating or source MAC address, the destination STA or STAs' MAC address—either unicast or broadcast/multicast, an identifier to uniquely identify the request, and the classifier rules that may match the messages sent by the HLE 1310. The classifier rules typically includes the information so as to configure the classifier on the STA, STA A 110, for the requested connection, e.g., source Internet Protocol (IP) address, source IP port, destination IP address, destination IP port. In some embodiments, the classifier rules include rule priority and classifier parameters. The CSPEC being passed, typically via a connection request, e.g., the request message 1352, is the CSPEC shown, for example, in Table IV above. The CSPEC defined between the higher layer entity and the lower layer entity thus is tailored between these two protocol entities.

The CM 1312 on the STA 110 that initiated the connection then sends a CM_CONN_NEW.REQ message 1354 requesting the terminating station(s), in this exemplary embodiment, STA B 118 to add a new connection. This request 1354 typically includes the MAC address of the source or initiating STA, MAC address of the terminating or destination STA, the connection ID identifying the connection being negotiated, and the CSPEC of the new connection. The CSPEC, however, being passed between the two CMs 1312, 1322 is typically the CSPEC exemplified in Table IV above, with additional parameters shown in Table V above.

The CM 1322 at the terminating STA, STA B 118, then informs its associated higher layer HLE 1320 of the requested new connection, e.g., via an APCM_CONN_ADD.IND message 1356. The CSPEC 1356 that is typically passed, with the exemplary APCM_CONN_ADD.IND message, between the CM 1322 and the HLE 1320, however, is the CSPEC that is typically defined between an HLE and a CM as exemplified in Table IV above. Thus, the additional parameters, tailored between two stations, are not necessarily passed between the higher and lower layer entities, e.g., the additional parameters shown in Table V above. The HLE 1320 of the terminating STA then responds, e.g., via an APCM_CONN_ADD.RSP 1358. If the HLE 1320 accepts, the HLE also provides the CM 1322 on the terminating side of the connection the classifier rules that may match the messages in the reverse direction, so the classifier may direct them to the appropriate link. In some embodiments, the HLE 1320 may also send a proposed CSPEC 1358 indicating the CSPEC that the HLE 1320 is currently capable of supporting if the new connection failed. In some embodiments, if a proposed CSPEC is not included with the response 1358, the failure typically is for a reason not related to an inability to support the CSPEC. The response 1358 also typically includes a result code indicating whether the add or new connection request is successful or has failed. The CM 1322 at the terminating STA then sends a CM_CONN_ADD.CNF message 1360 to the CM 1312 of the initiating station, STA A 110, indicating whether the connection request is accepted or rejected. If the negotiation between the CMs is successful to establish a connection or local links between the exemplary two stations, and no global links from the CCO have to be requested, the connection setup or establishment between the two stations 1370 is complete and typically each of the HLEs 1310, 1320 is notified via appropriate confirming messages indicating the connection has been successfully established. After this point 1388, typically the CMs 1312, 1322 may now start exchanging packets belonging to that connection.

If the connection negotiation between the CMs 1312, 1322 is unsuccessful, however, the connection setup is deemed as failed. In the case of broadcast/multicast link, it is possible that some of the destination CMs may have accepted the connection while other have rejected. In this case, the initiating CM typically 1312 sends a CM_CONN_REL.IND message indicating failure of the connection setup to all CMs that accepted the connection and thus the requested connection should appropriately be released. The CMs are also typically responsible for configuring the classifiers to identify packets belonging to links. When a connection setup request was rejected by the CM due to insufficient station resources or rejected by the CCO due to insufficient bandwidth, a proposed CSPEC containing the fields of the CSPEC that may currently be supported may be communicated to the stations belonging to the connection. This enables the application/HLE or the CM to establish a new connection for the streams within the limits of the proposed CSPEC. An HLE may typically request the performance statistics for its connection from the CM, particularly the QoS monitor module 1260, at any time.

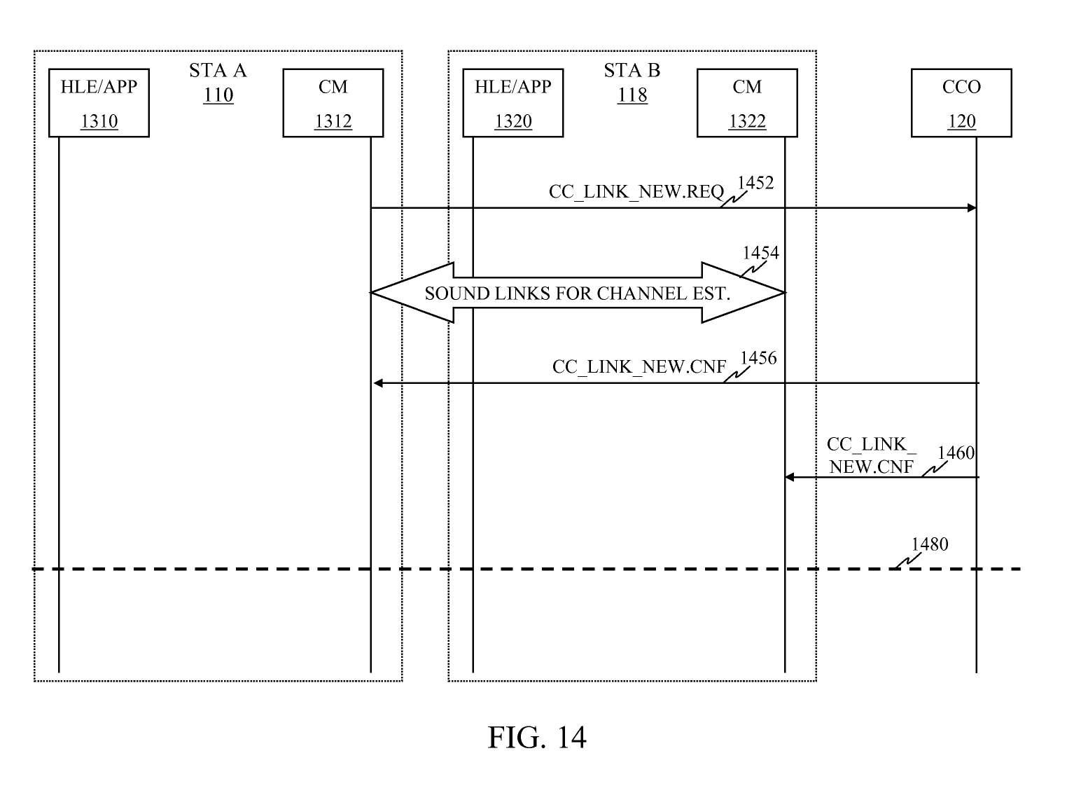

FIG. 14 is a high level data flow diagram showing how a connection may be requested by a STA 110 from the CCO. Further expounding on the example on FIG. 13, if the negotiation between the CMs 1312, 1322 is successful and if global links are required, typically the initiating CM 1310 that initiated the connection then sends a CC_LINK_NEW.REQ 1452 to the CCO 120 requesting connection setup in the contention-free period. This exemplary CC_LINK_NEW.REQ typically includes a CSPEC that is tailored between a STA and a CCO, as exemplified in Table VI above. The CCO 120 then sends a CC_LINK_NEW.CNF message 1456, 1460 to all stations, STA A 110 and STA B 118, belonging to the requested connection to indicate the success or failure of the connection setup or establishment procedure. The CCO 120 may also establish global links for sounding 1454 to facilitate channel adaptation between the two stations 110, 118 before establishing a global link. Typically, each global link enables channel adaptation from the source station of a global link to the destination station of the global link. After the global links are established 1480, the stations may accordingly use the global links in the CFP to transmit data.

Based on the above examples, the CSPEC, typically being passed between the various entities, is dependent on whether the connection request or the connection is between a higher layer entity and a lower layer entity, between at least two stations, and between a station and a CCO. This classification, for example, means that the CSPEC being passed between the higher layer entity and a lower layer entity is different from the CSPEC passed between stations, particularly between their CMs, and is also different from the CSPEC passed between the CM to the CCO. The CSPEC being passed between the two stations is also different from the CSPEC being passed between the station and the CCO. The CSPEC being passed between these three classifications, however, may include redundant information, for example, the CDESC that is used by the HLE, but the CSPEC, however, is considered different, because additional parameters may have been added and/or some parameters have been removed, i.e., the set of parameters defining the CSPEC is different for each classification.

The above figures, particularly FIGS. 13 and 14, show an exemplary exchange of messages associated with a connection request between the various CSPEC

Connection Reconfiguration

In some embodiments, connection reconfiguration may occur when the CSPEC parameters of the connection change. Connection reconfiguration may occur, for example, if an HLE initiates a change in CSPEC for reasons specific to the application or the CM initiates a change in CSPEC when the CM determines that the CSPEC parameters have changed. In general, the connection re-configuration process is similar to the new connection establishment process. Failure to reconfigure a connection, in some embodiments, typically does not cause the existing connection to be dropped.

Acceptance of a connection re-configuration request for connections involving global links typically triggers the CM, particularly the admission and control module (ACM) 1250, to update the local resource allocations to support the modified connections. If the modification or reconfiguration is accepted, the CMs may start transmitting stream based on the new CSPEC. Rejection of the connection modification by CCO may cause the CMs to restore the local resource allocations.

When a connection reconfiguration request is rejected by the CM due to insufficient station resources or by the CCO due to insufficient bandwidth, a proposed CSPEC containing the fields of the CSPEC that may be currently supported is typically communicated to the stations belonging to the connection. This enables the application/HLE or the CM to establish a new connection for the streams within the limits of the proposed CSPEC.

When the HLE determines that the connection needs to be reconfigured, it negotiates with the other station for the reconfiguration, typically involving changes to the CSPEC parameters, and then requests the CM, particularly the ACM 1250, to modify the connection. The CM may also request the CCO for a reconfigured allocation, if the affected link is using the CFP, particularly, if they are global links.

In some embodiments, the CM initiates reconfiguration only when the exception policy in the CSPEC explicitly requires connection reconfiguration under CSPEC violation. If the CM in either station determines that the allocation needs to be reconfigured due to changes to CSPEC, e.g., due to changes in traffic characteristics, the CM typically negotiates directly with the CCO. The CCO may then accordingly notify the stations involved or associated with the connection of the revised allocation.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For example, the exemplary table formats described above may be varied, for example, additional fields added, fields deleted, fields replaced, fields subdivided into subfields, data field types changed, tables subdivided, tables merged, etc. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

We claim:

1. A method of establishing connections within a centralized network, the method comprising the steps of:
defining a connection specification (CSPEC) based on a CSPEC classification selected from at least one of the following:
between a higher layer entity and a lower layer entity;
between a first station and a second station; and
between a third station and a central coordinator (CCO);
requesting a connection associated with the defined CSPEC from at least one of the following:
wherein the requesting step is associated with the defined CSPEC based on the CSPEC classification between the higher layer entity and the lower layer entity when the requesting step is between the higher layer entity and the lower layer entity;
wherein the requesting step is associated with the defined CSPEC based on the CSPEC classification between the first station and the second station when the requesting step is between the first station and the second station; and
wherein the requesting step is associated with the defined CSPEC based on the CSPEC classification between the third station and the CCO when the requesting step is between the third station and the CCO; and
responding with a response indicating whether the requested connection has been granted or rejected.

2. The method of claim 1 wherein the third station is also either the first station or the second station.

3. The method of claim 1 wherein the defined CSPEC is associated with a connection descriptor (CDESC), wherein the CDESC comprises at least one of the following parameters:
Internet Protocol (IP) version;
source IP address;
source IP port;
destination IP address;
destination IP port; and
protocol type.

4. The method of claim 1 wherein the defined CSPEC comprises one or more Quality of Service (QoS) parameters.

5. The method of claim 1 wherein the defined CSPEC comprises one or more Media Access Control (MAC) parameters.

6. The method of claim 1 wherein the defined CSPEC comprises one or more MAC parameters and one or more QoS parameters.

7. The method of claim 1 further comprising the step of establishing the requested connection when the requested connection is granted.

8. The method of claim 1 wherein the defined CSPEC comprises one or more link information.

9. The method of claim 1 wherein the defined CSPEC based on the CSPEC classification between the higher layer entity and the lower layer entity comprises an indication of a contention-free service, an average data rate parameter for transporting MAC service data units (MSDU) associated with the connection; at least one delay bound parameter indicating a maximum amount of time to transport an MSDU, and at least one maximum inter-transmission opportunity (TXOP) parameter indicating the minimum time between two TXOPs.

10. The method of claim 1 wherein the defined CSPEC based on the CSPEC classification between the first station and the second station comprises a receive window size parameter.

11. The method of claim 1 wherein the defined CSPEC based on the CSPEC classification between the third station and the CCO comprises an indication of a contention-free service, a number of uniformly spaced transmission opportunities (TXOPs) per beacon period, and an average number of PHY blocks per TXOP.

12. The method of claim 1 wherein the centralized network is a power line communication network.

13. The method of claim 1 wherein the defined CSPEC comprises a proposed CSPEC.

14. A device adapted to be operably coupled to a centralized network, the centralized network applying a connection specification classification based on whether a connection specification (CSPEC) is between a higher layer entity and a lower layer entity, between peer stations, and between a station and a central coordinator, with the central coordinator coordinating network activities, the device comprising:
an admission control module (ACM) adapted to:
grant or reject a connection associated with a connection request from one or more stations within the network, wherein the connection request is associated with a CSPEC defined within the centralized network to be applied between peer stations; and
a quality of service monitor module operably coupled to the ACM and adapted to:
monitor the connection granted by the ACM;
gather statistics for the connection granted by the ACM;
reconfigure the connection granted by the ACM when one or more violations of the associated CSPEC occur or when the associated CSPEC is modified; and
teardown the connection granted by the ACM when the one or more violations of the associated CSPEC occur or when a teardown request of the connection is received.

15. The device of claim 14 wherein the connection request is a request for connection establishment.

16. The device of claim 14 wherein the connection request is a request for connection reconfiguration.

17. The device of claim 14 wherein the connection request is a request for a connection within a contention-free period.

18. The device of claim 14 wherein the connection request is a request for a connection within a contention period.

19. A central coordinator device adapted to be operably coupled to a centralized network, the centralized network applying a connection specification classification based on whether a connection specification (CSPEC) is between a higher layer entity and a lower layer entity, between peer stations, and between a station and a central coordinator, with the central coordinator coordinating network activities, the device comprising:
a bandwidth (BW) scheduling and allocation module adapted to:
grant or reject a connection associated with a connection request from one or more stations within the network, wherein the connection request is associated with a CSPEC defined within the centralized network to be applied between a station and a central coordinator; and
schedule one or more time intervals for the connection within a contention-free period when the connection is granted; and
a beacon configuration and transmission module operably coupled to the BW scheduling and allocation module and adapted to:
define a new beacon, once every beacon period, based on the scheduled one or more time intervals scheduled by the BW scheduling and allocation module; and
transmit the defined beacon once every beacon period.

20. The device of claim 19 wherein the connection request is a request for connection establishment.

21. The device of claim 19 wherein the connection request is a request for connection reconfiguration.

22. The device of claim 19 wherein the connection request is a request for a connection within a contention-free period.

23. The device of claim 19 wherein the BW scheduling and allocation module is further adapted to:
release the one or more scheduled time intervals.

24. A system comprising:
a central coordinator (CCO) operably coupled to a first station and a second station, the CCO adapted to:
receive a request for a connection from at least one station, wherein the connection is associated with a connection specification (CSPEC) tailored between the CCO and a station, wherein the at least one station is selected from the group comprising the first station and a second station;
the first station operably coupled to the second station:
wherein the first station is adapted to receive a request for a connection from the second station, wherein the connection is associated with a connection specification (CSPEC) tailored between peer stations; and
wherein the first station comprises a first higher layer entity and a first lower layer entity adapted to receive a CSPEC tailored between a higher layer entity and a lower layer entity; and
the second station operably coupled to the first station:
wherein the second station is adapted to receive a request for a connection from the first station, wherein the connection is associated with a CSPEC tailored between peer stations; and
wherein the second station comprises a second higher layer entity and a second lower layer entity adapted to receive a CSPEC tailored between a higher layer entity and a lower layer entity;
wherein the system is a power line communication network.
